(19) United States
(12) Patent Application Publication
(10) Pub. No.: US 2004/0177380 A1
(43) Pub. Date: Sep. 9, 2004

(54) Method and system using docking stations to distribute a set top box between multiple monitors

(75) Inventors: Kenneth L. Hamel, Louisville, CO (US); Scott Brenner, Superior, CO (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA

(21) Appl. No.: 10/383,015

(22) Filed: Mar. 6, 2003

(51) Int. Cl. H04N 7/18; H04N 7/16; H04N 7/173; H04N 5/44; H04N 9/47

(52) U.S. Cl. 725/131; 348/725; 348/139; 725/139; 725/151

(57) ABSTRACT

A method and system for distributing a decoded audio/video broadcast programming signal to a monitor includes using a set top box (STB) docked with a docking station, connected to a television. The method and system provides a subscriber of the broadcast programming the distribution of the STB amongst docking stations and associated televisions. The STB may include a video recorder for recording audio/video broadcast programming. The docking station may contain an identifier that the STB can recognize and use to limit or expand the decoded audio/video broadcast programming signal.

### BACKGROUND OF THE INVENTION

1. Field of the Invention

The present invention relates to a set top box (STB) docking station connected between a programming source and a monitor to act as an abstract interface between the programming source and the monitor for a STB removably docked in the docking station.

2. Background Art

Cable and satellite broadcast service providers offer subscribers hundreds of channels of analog, digital, and high definition broadcast programming. Subscribers use a set top box (STB), either purchased or leased from the service provider, to access programming channels on a monitor such as a television (TV).

A STB is a relatively expensive electronic device which acts as a receiver, tuner, and decoder of encoded programming signals provided by the broadcast service provider. A TV requires a decoded programming signal to present the broadcast programming to an audience. The STB is operable to generate a decoded programming signal from an encoded programming signal for the TV. The STB provides service subscribers access to various digital, audio, and interactive television services, including expanded channel counts; digital-quality video and audio; interactive program guides for viewing convenience and control; parental control; and virtual channels for community and local information provided by the broadcast service providers.

Currently, most subscribers lease a STB from the service provider for each TV in the household. In order for a subscriber to access the broadcast programming on multiple TVs, the subscriber is required to lease an additional STB for each TV. That is, each TV typically has its own STB. The subscriber may circumvent this requirement by moving a STB from TV to TV. Purchasing a STB may not be feasible because the STB platform may need to be upgraded when new formats or programming is introduced. Also, if a subscriber moves to a location with a different broadcast service provider, that subscriber may have a different programming signal format incompatible with the subscriber's former provider.

Furthermore, connection and reconnection of a STB to a TV and a programming source connection, such as a wall connection, is timely, inconvenient, and cumbersome. For example, often times moving the STB from one TV to another TV requires the movement of furniture and the TV in order to access the wires and cable connections.

Thus, there exists a need for a method and system that would allow a subscriber to use one STB amongst a plurality of TVs in a subscriber's home. Such a method and system would eliminate the need to directly connect a STB between a TV and a programming source. With such a method and system, the connection and disconnection of the STB with the broadcast programming source and the TV would be connected indirectly without the use of direct cable connections from the STB to either of the TV and the programming source. As a result, the connection of the STB between the TV and the programming source would be inexpensive, easy, convenient, and reliable.

### SUMMARY OF THE INVENTION

Accordingly, the present invention is directed to a set top box (STB) docking station that substantially obviates one or more of the problems due to the limitations and disadvantages of the related prior art.

In one embodiment, the invention provides an audio/video broadcast programming distribution system. The systems includes a docking station having an audio/video input connection and an audio/video output connection. The audio/video input connection is connected to a broadcast programming source in order to receive an encoded audio/video programming signal. The audio/video output connection is connected to a monitor in order to provide a signal to the monitor. The STB is removably docked to the docking station and receives the encoded audio/video programming signal from the docking station. The STB decodes the encoded audio/video programming signal and provides the decoded audio/video programming signal to the docking station. The docking station provides the decoded audio/video programming signal to the monitor via the audio/video output connection.

The STB may include a tuner, a receiver, and a decoder operable to receive the encoded audio/video programming signal and to decode and tune the encoded audio/video programming signal. The STB may further include a programmable video recorder for recording the decoded audio/video programming signal. The monitor can be a television or a computer monitor.

The docking station may have an identifier. When the STB is docked to the docking staton, the STB may receive the identifier from the docking station. The STB may block a portion of the decoded audio/video programming signal from being provided to the docking station based on the identifier of the docking station.

In another embodiment, a device provides a decoded audio/video programming signal from a STB to a monitor. The STB is operable for generating a decoded audio/video programming signal. The device includes a docking station having an input and an output. The input of the docking station is connectable to a programming source in order to receive an encoded audio/video programming signal. The docking station is dockable with the STB and provides the encoded audio/video programming signal to the STB and receives a decoded audio/video programming signal generated by the STB. The output of the docking station is connectable to the monitor in order to provide the decoded audio/video programming signal to the monitor.

In yet another embodiment, a method is provided for broadcasting programming on one of at least two monitors using a STB operable for generating a decoded programming signal from an encoded programming signal. The method provides for each of the at least two monitors, an associated docking station having an input and an output. The input of each docking station is connected to a programming source in order for the docking station to receive an encoded programming signal from the programming source. The output of each docking station is connected to the associated one of the at least two monitors. The STB is removably docked to one of the docking stations in order for the STB to receive the encoded programming signal from the input of the docking stations. The STB then provides a decoded programming signal to the docking stations. The docking station provides the decoded programming signal to the monitor associated with the one of the docking stations via the output of the one of the docking stations.

The method may also provide recording the decoded programming signal using a video recorder in the STB.

The method may further provide each docking station has a respective identifier. Upon docking the STB to the one of the docking stations, the STB may read the identifier from the one of the docking stations. The STB may block a portion of the decoded programming signal provided to the one of the docking stations based on the identifier of the one of the docking stations.

The advantages according to the present invention are numerous. For instance, the present invention enables a subscriber to lease only one STB and be able to easily use this one STB amongst different televisions. Further, the present invention may provide a programmable video recorder in this STB such that the subscriber is able to easily use one video recorder amongst different televisions. Also, the present invention may provide an identifier with the docking station such that the STB when docked in the docking station is aware of the identity of the docking station for television channel blocking purposes and the like.

### BRIEF DESCRIPTION OF THE DRAWINGS

FIG. 1 illustrates a block diagram of an audio/video broadcast programming distribution system in accordance with an embodiment of the present invention;

FIGS. 2a and 2b respectively illustrate top and rear views of the docking station of the system shown in FIG. 1;

FIGS. 3a and 3b respectively illustrate bottom and front views of the set top box (STB) of the system shown in FIG. 1;

FIGS. 4a and 4b respectively illustrate top and side views of the docking of the STB into the docking station of the system shown in FIG. 1; and

FIG. 5 illustrates a sketch illustrating the distribution of the STB between multiple docking stations in which each docking station is associated with a respective TV.

### DETAILED DESCRIPTION OF THE PREFERRED EMBODIMENTS

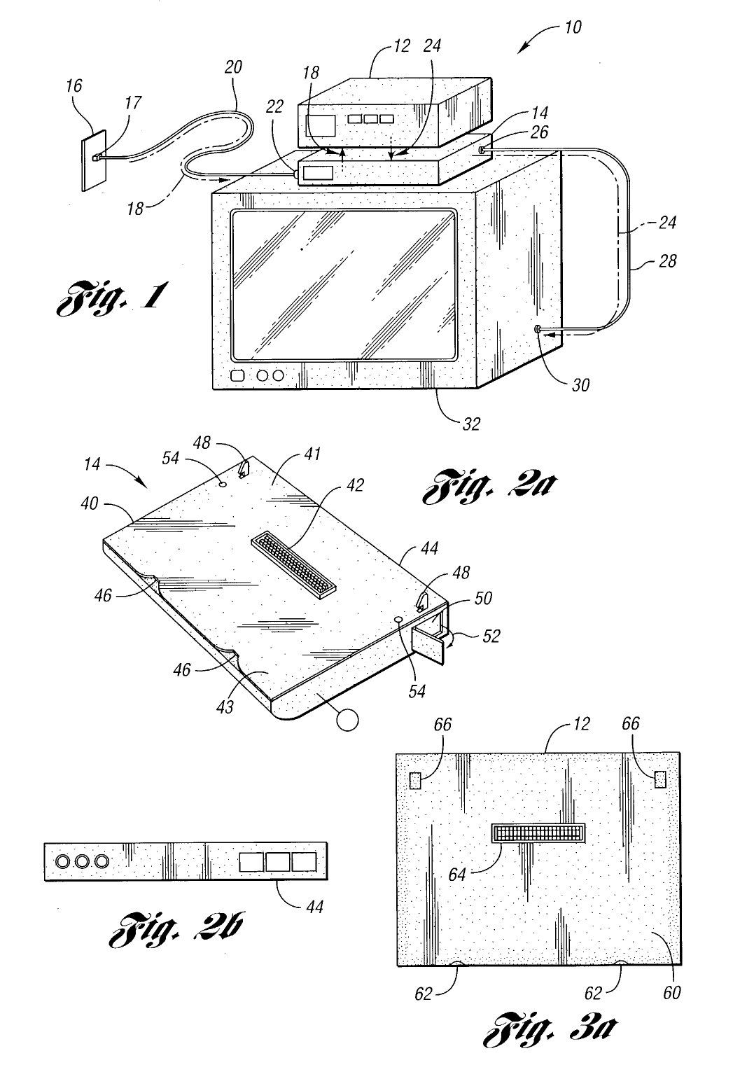

With reference to FIG. 1, an audio/video broadcast programming system 10 in accordance with a first embodiment of the present invention is shown. System 10 allows a set top box (STB) 12 to be docked to a docking station 14. The term “docked” is defined herein as being physically and electrically connected to a particular structure.

In general, STB 12 removably docks within docking station 14 in order to decode encoded programming signal 18 received by the docking station from an audio/video programming source 16. STB 12 provides the decoded programming signal 24 to a monitor 32, such as a television (TV) or computer monitor, via docking station 14. As the programming signals are decoded, TV 32 is able to present the programming contained therein to viewers. STB 12 may then be removed from docking within docking station 14 and docked within a second docking station in order to provide decoded programming signal 24 to a second TV associated with the second docking station.

Audio/video programming source 16 transmits an encoded audio/video programming signal 18 through a cable connection 20 to a docking station input 22. Typically, cable connection 20 connects docking station input 22 to audio/video programming source 16 via a wall connector 17. When STB 12 is docked with docking station 14, the STB receives the encoded audio/video programming signal 18 from the docking station. STB 12 then tunes and decodes the encoded audio/video programming signal 18 to generate a decoded audio/video programming signal 24. STB 12 then sends decoded signal 24 to docking station 14. Docking station 14 then sends the decoded audio/video programming signal 24 through a docking station output 26 to TV input 30 via a cable connection 28. TV 32 then presents the decoded audio/video programming signal 24 via a cable connection 28 as audio/video broadcast programming to subscribers.

STB 12, docking station 14, and TV 32 may each be controlled by a remote control, such as a radio frequency remote. System 10 may also have the capability to allow the subscriber to surf the Internet along with viewing the digital broadcast programming. Surfing the Internet would require additional input and output connections between docking station 14 and the TV 32. STB 12 would decode the programming signal to access the Internet, similar to a cable modem, for accessing the Internet on TV 32.

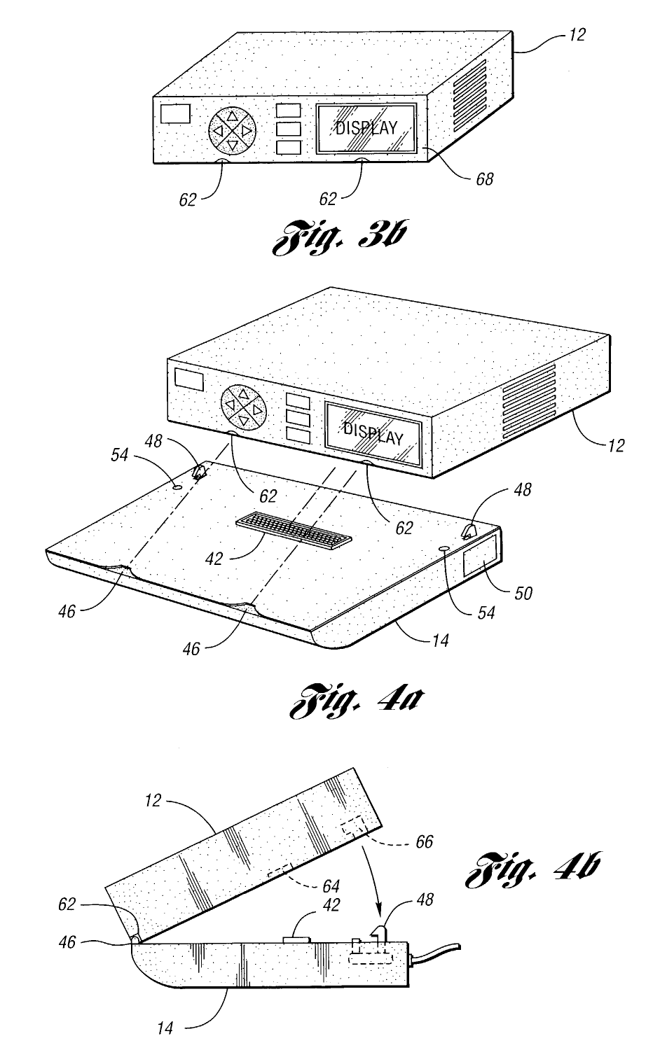

With reference to FIGS. 2a and 2b respectively illustrates top and rear views of docking station 14 of the system shown in FIG. 1. Docking station 14 allows STB 12 to be docked within the docking station. In addition to accommodating STB 12, docking station 14 allows a number of external devices to be electrically connected to the docking station. The external devices that can be connected to docking station 14 may include, but are not limited to a monitor, a computer, and a sound system.

Docking station 14 includes a housing 40 having a top lateral surface 41 configured to physically receive and accommodate STB 12. Lateral surface 41 includes a docking connector 42 that can mate with a compatible docking connector 64 (shown in FIG. 3a) on STB 12 located on the bottom of the STB. The type of docking connector 42 on docking station 14 depends on the type of docking connector 64 of the STB 12. As an example, docking connector 42 of docking station 14 may be a male 240 pin docking connector that can mate with a female docking connector on STB 12.

Docking connector 42 on lateral surface 41 of docking station housing 40 is electrically coupled to a number of connectors on a back surface 44 of the docking station housing. Examples of inputs and outputs may include video, s-video, digital television, satellite, data, antenna, and optical. Docking station 14 may also have the capability of allowing an analog signal to pass through the docking station and to send to the connected monitor 32. The analog signal is often an decoded signal that monitor 32 may present without the need of STB 12.

Docking station 14 also has two receiving pegs 46 to receive STB receiving notches 62 (shown in FIG. 3a). Pegs 46 are located along a front lateral edge surface 43 of docking station 14. Docking station 14 also includes two locking and guiding pegs 48 in a rear lateral surface for the purpose of receiving and locking in STB 12 into docking station 14. Docking station 14 also contains a release lever 50 on both sides of the docking station. When lever 50 is pulled in the direction shown by arrow 52, the lever unlocks the locking and guiding pegs 48 to release STB 12 and also actuates two push up rods 54 to enable the set top box to be raised and released.

FIGS. 3a and 3b respectively illustrate bottom and front views of the STB shown in FIG. 1. STB bottom surface 60 contains two receiving notches 62 in the front to accommodate a proper fit with receiving pegs 46 of docking station 14. STB bottom surface 60 also contains docking connector 64 and receiving and placement holes 66 for aligning locking and guiding pegs 48 of docking station 14.

The front of STB 68 may contain buttons and displays for various features and functionality of the STB. Buttons and displays may include, but are not limited to: power, menu, exit, info, action, enter, mode, and may integrate a joystick-like cursor selection system.

STB 12 may also integrate a digital video recorder (DVR) to decode and record audio/video programming. The DVR of STB 12 contains a hard disk or other storage medium to digitally record the decoded audio/video programming signal to be viewed at the subscriber's convenience. The DVR of STB 12 may also include programming options and other “smart” programming options. STB 12 may also include an Internet or a network connection for monitoring usage and providing programming options for the DVR. “Smart” programming options include programming the DVR to record the same shows or genres of shows matched with the subscriber's interest. For example, the DVR can be programmed to record all Yankee baseball games or shows with a certain actor or actress. The DVR may also allow the subscriber to view “live” audio/video programming with the functionality of the DVR options such as freezing, replaying, slow motion, or instant replay of “live” audio/video programming. The DVR also allows the subscriber during playback of the recorded programming to view the audio/video programming with options such as pausing, rewinding, advancing or slow motioning. The DVR of STB 12 can also allow a subscriber to go to another location, i.e. a friend's home or vacation home, with a compatible docking station and access the audio/video programming contents of the hard drive of the DVR for viewing at that location.

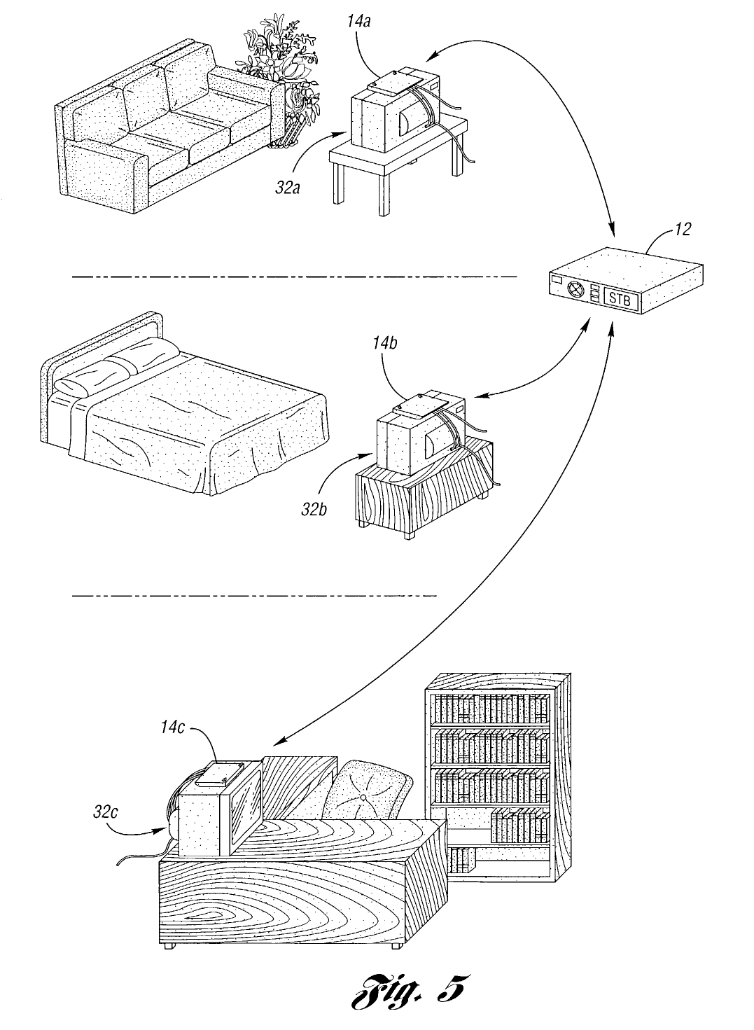

FIGS. 4a and 4b respectively illustrate bottom and side views of the docking of STB 12 into docking station 14. STB 12 has two receiving notches 60 to accommodate the two receiving pegs 46 on docking station 14. Docking station 14 then receives STB 12, making connection with STB docking connector 64 with docking station docking connector 42. Docking station 14 also has locking and guiding pins 48 to accommodate receiving holes 66 in the back of STB 12 in order to lock-in and secure the STB into place with the docking station. STB 12 can be undocked from the docking station by pulling on the release levers 50 for docking station locking and guiding pegs 48. Pulling on lever 50 also releases the groove of guiding pegs 48 and pushes STB 12 up with two push up rods 54 triggered by the lever. The user can then take STB 12 and move the STB to another docking station, as described in the invention.

Referring now to FIG. 5, a sketch illustrating the distribution of STB 12 between multiple docking stations 14a, 14b, and 14c. Each docking station 14a, 14b, and 14c is associated and connected to a respective TV 32a, 32b, and 32c in a home. STB 12 can be docked within any docking station 14a, 14b, and 14c. The docking station and the TV of each separate unit is capable of storing the settings for that particular unit with the associated docking station. This diagram shows that only one STB is needed to access digital TV programming in a home with a plurality of TVs with associated docking stations. Thus, the need to purchase or lease additional STBs is eliminated. Also, STB 12 at the time of an upgrade can be exchanged with greater efficiency and those future upgrades may be compatible with the current docking station system, thus making upgradeability of the STB seamless.

STB 12 may also have the capability to recognize the difference between multiple docking stations 14a, 14b, and 14c and their respective connected TVs 32a, 32b, and 32c. Docking stations 14a, 14b, and 14c can each have an individual identifier. STB 12 can recognize the identifier and determine the level of programming allowed based on the identifier associated with that docking station. STB 12 would limit the access to certain channels based on the programming the settings of the particular unit. For example, docking station 14a and TV 32a in a living room would have certain channels accessible, while a docking station 14b and TV 32b in a bedroom room could have a completely different set of channels accessible. This feature could be a form of parental control for docking stations and TVs based on their settings.

STB 12 may also include parental control features. STB 12 can restrict the viewing of any specific program titles and channels. Once a program is restricted, it can only be viewed by entering the parental control code into STB 12. The parental control feature can be used in conjunction with capability of STB 12 to recognize docking stations 14a, 14b, and 14c. For example, no parental control codes would be required on TV 32b in the bedroom, while parental control codes would have to be entered to view channels on TV 32a of the living room. Thus the invention would eliminate the need to constantly change codes and enter codes.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An audio/video broadcast programming distribution system comprising:
a docking station having an audio/video input connection and an audio/video output connection, the audio/video input connection of the docking station being connected to a broadcast programming source in order to receive an encoded audio/video programming signal, and the audio/video output connection being connected to a monitor in order to provide a signal to the monitor; and
a set top box removably docked to the docking station, wherein, upon being docked to the docking station, the set top box receives the encoded audio/video programming signal from the docking station, decodes the encoded audio/video programming signal to generate a decoded audio/video programming signal, and provides the decoded audio/video programming signal to the docking station;
wherein the docking station provides the decoded audio/video programming signal to the monitor via the audio/video output connection.

2. The system of claim 1, wherein the set top box further comprises a tuner, a receiver, and a decoder operable to receive the encoded audio/video programming signal and to decode and tune the encoded audio/video programming signal.

3. The system unit of claim 1, wherein the set top box further comprises a programmable video recorder for recording the decoded audio/video programming signal.

4. The system unit of claim 1, wherein the monitor is a television.

5. The system unit of claim 1, wherein the monitor is a computer monitor.

6. The system of claim 1, wherein:
the docking station has an identifier;
the set top box receives the identifier from the docking station upon being docked to the docking station; and
wherein the set top box blocks a portion of the decoded audio/video programming signal from being provided to the docking station based on the identifier of the docking station.

7. A device for providing a decoded audio/video programming signal from a set top box to a monitor, wherein the set top box is operable for generating a decoded audio/video programming signal from an encoded audio/video programming signal, the device comprising:
a docking station having an input and an output, the input of the docking station being connectable to a programming source in order to receive an encoded audio/video programming signal from the programming source, the docking station being dockable with a set top box, the docking station providing the encoded audio/video programming signal to a docked set top box and receiving a decoded audio/video programming signal generated by the docked set top box, the output of the docking station being connectable to the monitor in order to provide the decoded audio/video programming signal to the monitor.

8. A method for broadcasting programming on one of at least two monitors using a set top box operable for generating a decoded programming signal from an encoded programming signal, the method comprising:
for each of the at least two monitors, providing an associated docking station having an input and an output;
connecting the input of each docking station to a programming source in order for the docking station to receive an encoded programming signal from the programming source;
connecting the output of each docking station to the associated one of the at least two monitors;
removably docking a set top box to one of the docking stations in order for the set top box to receive the encoded programming signal from the input of the one of the docking stations and provide a decoded programming signal to the one of the docking stations; and
providing the decoded programming signal from the one of the docking stations to the monitor associated with the one of the docking stations via the output of the one of the docking stations.

9. The method of claim 8, further comprising recording the decoded programming signal using a video recorder in the set top box.

10. The method of claim 7, wherein each docking station has a respective identifier, the method further comprising:
reading the identifier from the one of the docking stations with the set top box upon docking the set top box to the one of the docking stations; and
blocking a portion of the decoded programming signal provided by the set top box to the one of the docking stations based on the identifier of the one of the docking stations.
